(19) United States
(12) Patent Application Publication
(10) Pub. No.: US 2024/0326365 A1
(43) Pub. Date: Oct. 3, 2024

(54) TIRE WITH BAND LAYER

(71) Applicant: Bridgestone Americas Tire Operations, LLC, Nashville, TN (US)

(72) Inventors: Jared J. Griebel, Orange Village, OH (US); Benjamin E. Rimai, Copley, OH (US); Bradley S. Plotner, Canton, OH (US); Brandon P. Nelson, Stow, OH (US)

(21) Appl. No.: 18/038,343

(22) PCT Filed: Dec. 9, 2021
(86) PCT No.: PCT/US2021/072830

§ 371 Date: May 23, 2023

Related U.S. Application Data
(60) Provisional application No. 63/130,452, filed on Dec. 24, 2020.

(51) Int. Cl. B29D 30/02; B29D 30/58; B60C 7/06; B60C 7/10; B60C 7/14

(52) U.S. Cl. CPC B29D 30/02; B29D 30/58; B60C 7/06; B60C 7/10; B60C 7/14

(57) ABSTRACT

A method of making a tire tread includes providing a sheet of material and forming the sheet of material into a cylinder, such that a first edge of the sheet of material contacts a second edge of the sheet of material. The method also includes welding the first edge to the second edge to form a welded joint of a seamed cylinder, and providing tread rubber about the seamed cylinder.

### FIELD OF INVENTION

The present disclosure relates to a tire, and a method of making the same. More particularly, the present disclosure relates to a tire with a band layer attached to a tread rubber layer, and a method of making the same.

### BACKGROUND

Various tire constructions have been developed which enable a tire to run in an uninflated or underinflated condition. Non-pneumatic tires do not require inflation, while “run flat tires” may continue to operate after receiving a puncture and a complete or partial loss of pressurized air, for extended periods of time and at relatively high speeds. Non-pneumatic tires may include a plurality of spokes, a webbing, or other support structure that connects a lower ring to an upper ring. In some non-pneumatic tires, a circumferential tread may be wrapped about the upper ring of the tire.

The circumferential tread of a tire may contain a shear element having an elastic region disposed between upper and lower inelastic regions. The shear element may also be referred to as a shear band, a tread band, or a thin annular high strength band element. When used in a pneumatic tire, the shear element acts as a tension member when the tire is pressurized. When used in a non-pneumatic tire, or a pneumatic tire in an unpressurized or partially pressurized state, the shear element acts as a structural compression member.

### SUMMARY OF THE INVENTION

In one embodiment, a non-pneumatic tire includes a lower ring having an axis of rotation and an upper ring coaxial with the lower ring. The non-pneumatic tire further includes support structure extending from the lower ring to the upper ring, and a circumferential tread extending about the upper ring. The circumferential tread includes a band layer formed by a seamed cylinder constructed of a single material and a tread rubber layer directly attached to the band layer.

In another embodiment, a method of making a non-pneumatic tire includes providing an assembly with a lower ring, an upper ring coaxial with the lower ring, and support structure extending from the lower ring to the upper ring. The method also includes providing a sheet of material and forming the sheet of material into a cylinder, such that a first edge of the sheet of material contacts a second edge of the sheet of material. The method further includes welding the first edge to the second edge to form a welded joint of a seamed cylinder. The method also includes placing the seamed cylinder about the upper ring, and providing tread rubber about the seamed cylinder.

In yet another embodiment, a method of making a tire tread includes providing a sheet of material and forming the sheet of material into a cylinder, such that a first edge of the sheet of material contacts a second edge of the sheet of material. The method also includes welding the first edge to the second edge to form a welded joint of a seamed cylinder, and providing tread rubber about the seamed cylinder.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a front view of an undeformed non-pneumatic tire;

FIG. 2 is a front view of the non-pneumatic tire of FIG. 1 being deformed when subjected to a load;

FIG. 3 is a schematic drawing illustrating a partial cross-section along line 3-3 of the non-pneumatic tire of FIG. 1;

FIG. 4A is a front plan view of one embodiment of a sheet of metal or high strength polymeric material;

FIG. 4B is a perspective view of one embodiment of a seamed cylinder formed from the sheet of FIG. 4A;

FIG. 5A is a front plan view of an alternative embodiment of a sheet of metal or high strength polymeric material;

FIG. 5B is a perspective view of one embodiment of a cylinder formed from the sheet of FIG. 5A;

FIG. 6A is a front plan view of another alternative embodiment of a sheet of metal or high strength polymeric material;

FIG. 6B is a perspective view of one embodiment of a cylinder formed from the sheet of FIG. 6A;

FIG. 7A is a cross-sectional view of one embodiment of a reverse flow forming system for forming a cylinder;

FIG. 7B is a front view of the reverse flow forming system of FIG. 7A;

FIG. 8A is a perspective view of the cylinder of FIG. 6B with arrows showing one embodiment of a direction of travel during a flow forming process; and

FIG. 8B is a perspective view of the cylinder of FIG. 6B with arrows showing an alternative embodiment of a direction of travel during a flow forming process.

### DETAILED DESCRIPTION

The following includes definitions of selected terms employed herein. The definitions include various examples or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Tread” as used herein, refers to that portion of the tire that comes into contact with the road or ground under normal inflation and normal load.

While similar terms used in the following descriptions describe common tire components, it should be understood that because the terms carry slightly different connotations, one of ordinary skill in the art would not consider any one of the following terms to be purely interchangeable with another term used to describe a common tire component.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the side of the tire. Thus, when relative directional terms such as “inner” and “outer” are used in connection with an element, the “inner” element is spaced closer to the equatorial plane of the tire than the “outer” element.

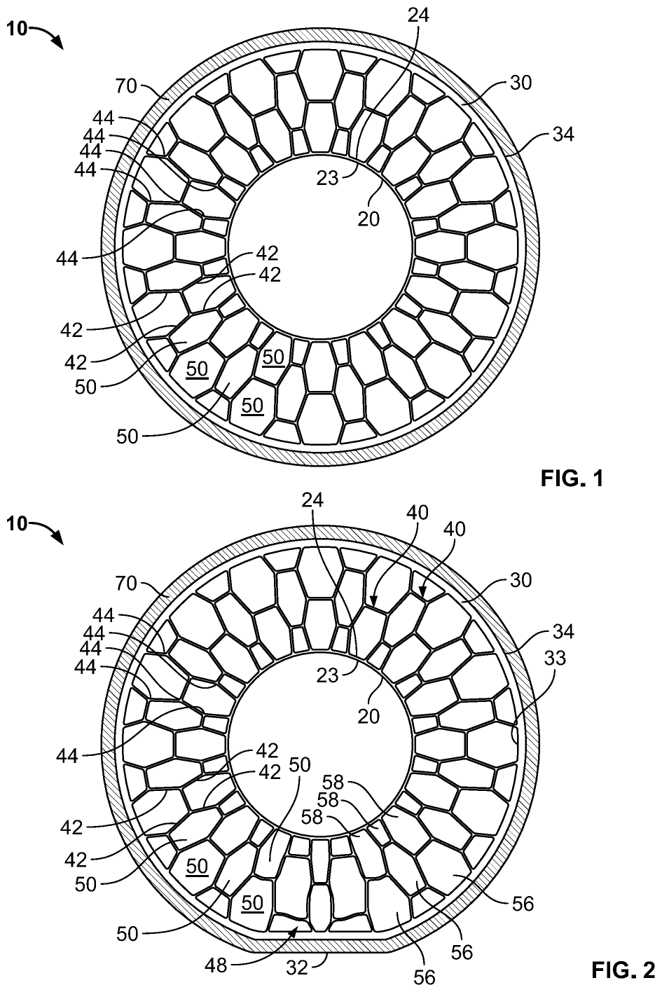

FIGS. 1 and 2 illustrate one embodiment of a non-pneumatic tire 10. The non-pneumatic tire 10 is merely an exemplary illustration and is not intended to be limiting. In the illustrated embodiment, the non-pneumatic tire 10 includes a generally annular lower ring 20 that engages a rim (not shown) to which the tire 10 is mounted. The generally annular lower ring 20 has an internal surface 23 and an external surface 24 and can be made of an elastomeric material or metal.

The non-pneumatic tire 10 further includes a generally annular upper ring 30 surrounding an interconnected web 40, which is a support structure connected to the generally annular lower ring 20. In alternative embodiments, a plurality of spokes or other support structure connects the lower ring to the upper ring. The upper ring 30 can be configured to deform in an area 48 around and including a footprint region 32 (see FIG. 2), which decreases vibration and increases ride comfort.

In one embodiment, the generally annular lower ring 20 and the generally annular upper ring 30 are made of the same material as interconnected web 40. In an alternative embodiment, at least one of the generally annular lower ring, the generally annular upper ring, and the interconnected web are made of a different material. As shown in FIG. 1, the generally annular upper ring 30 can have a radially external surface 34 to which a tread carrying layer 70 is attached. Attachment can be done adhesively or using other methods commonly available in the art.

In the illustrated embodiment, the interconnected web 40 has at least two radially adjacent layers 56, 58 of web elements 42 that define a plurality of generally polygonal openings 50. In other embodiments (not shown), other web configurations may be employed. In another embodiment (not shown), spokes or other support structure may be employed instead of a web.

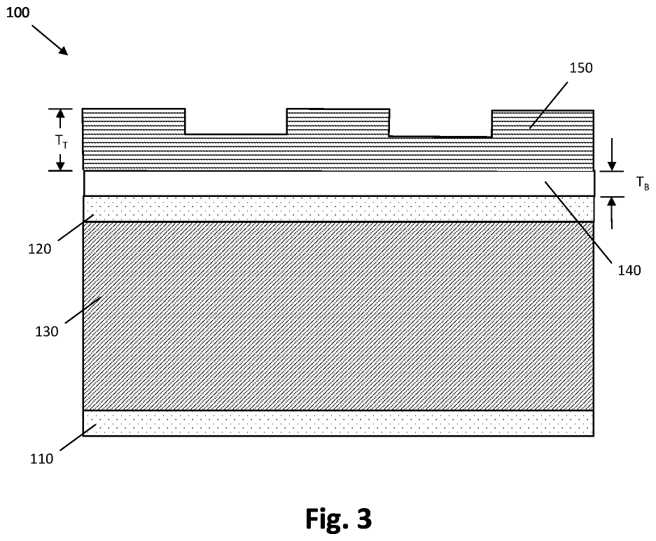

FIG. 3 is a schematic drawing illustrating a partial cross-section of one embodiment of a non-pneumatic tire 100. In this embodiment, the non-pneumatic tire 100 includes a tire structure having a lower ring 110, an upper ring 120, and a support structure 130 extending from the lower ring to the upper ring. In one embodiment, the support structure 130 is a webbing, such as the webbing shown in FIGS. 1 and 2. In an alternative embodiment, the support structure includes a plurality of spokes. It should be understood, however, that any support structure may be employed.

The non-pneumatic tire 100 includes a circumferential tread having the same width as the upper ring 120. The circumferential tread includes a band layer 140 constructed of a single material. A tread rubber layer 150 is directly attached to the band layer 140. In an alternative embodiment (not shown), the circumferential tread is wider than the upper ring. In another alternative embodiment (not shown), the upper ring is wider than the circumferential tread.

The illustrated structure carries an applied load by resisting bending about its neutral axis. Bending of the band layer 140 assists in carrying a load on the non-pneumatic tire 100. If metal or other lossless materials are used for the band layer 140, rolling resistance and heat generation of the assembly can be reduced. This is a departure from prior polymeric shear layers having plies of steel cords. Such polymeric shear layers provide load carrying capability, at the expense of high rolling resistance and heat generation.

The single material of the band layer 140 may be a composite, or blend of multiple materials, but the band layer 140 is not formed of distinct layers of materials. In one embodiment, the band layer 140 is constructed of steel. In one specific embodiment, the band layer 140 is constructed of ultra high strength steel. Other exemplary materials include, without limitation, rubber, other metals such as aluminum, brass, copper, and stainless steel, or polymeric materials including polyurethane, polyester, and polyvinyl chloride (PVC).

Favorable performance may be achieved with a band layer constructed of a material having a high ultimate tensile strength and a surface finish with low surface roughness. In one embodiment, the band layer is constructed of a material having an ultimate tensile strength of at least 60,000 pounds of force per square inch (i.e., 60 ksi or 410 MPa). In another embodiment, the band layer is constructed of a material having an ultimate tensile strength of at least 120,000 pounds of force per square inch (i.e., 120 ksi or 830 MPa). In yet another embodiment, the band layer is constructed of a material having an ultimate tensile strength of at least 200,000 pounds of force per square inch (i.e., 200 ksi or 1400 MPa). A band layer constructed of a material having a high ultimate tensile strength has a better fatigue life.

Additionally, in one embodiment, the band layer is constructed of a material having an average surface roughness of less than 1000 micro inches (i.e., 25 microns). In another embodiment, the band layer is constructed of a material having an average surface roughness of less than 64 micro inches (i.e., 1.6 microns). In yet another embodiment, the band layer is constructed of a material having an average surface roughness of less than 32 micro inches (i.e., 0.8 microns). While a rougher finish may be better for adhesion, it has been found that a finer finish is better for fatigue life.

The ultimate tensile strengths and average surface roughnesses identified above may be found in high strength steel that has been prepared through a shot peening or laser shock peening process. The high strength steel may be specialty steel and may receive special heat treatment. Aluminum and titanium may also exhibit the ultimate tensile strengths and average surface roughnesses identified above.

In the illustrated embodiment, the band layer 140 has a band thickness T_{B}, and the tread rubber layer 150 has a tread thickness T_{T} that is greater than the band thickness T_{B}. In one known embodiment, the band thickness is between 0.010 inches and 0.300 inches (0.254 mm to 7.62 mm). However, other arrangements may be employed. The thicknesses of the band layer and the tread layer may be selected to provide desirable performance of the non-pneumatic tire. For example, it may be desirable to balance the bending stiffness of the band layer with the thickness of the band layer to regulate a bending moment about the neutral axis to carry a desired load at a desired deflection.

Selecting the thicknesses of the band layer and the tread rubber layer also allows the tire designer to select the location of a neutral axis of the circumferential tread. For example, the neutral axis location may be selected such that the circumferential tread would have different bending stiffness in different directions. If the neutral axis is closer to an outer diameter of the tire, the lead and trailing edge of the footprint will be harder to bend, thus increasing load carrying capacity. However, if the tire rolls over an object, it would have a lower bending stiffness in that direction thus allowing for easier envelopment and a more comfortable ride.

In selecting the materials and thicknesses of each layer, other factors may be considered. For example, it may be desirable to reduce the band layer thickness to reduce volume and weight, as well as the amount of heat generated during rotation of the tire. It may also be desirable, however, to increase band layer thickness to reduce stress in the band layer.

Additionally, it may be desirable to select the thickness and stiffness of the tread rubber layer and the band layer to regulate footprint length.

Such cylinders may have a diameter between 20-50 inches (50-130 cm). In more specific embodiments, the cylinder has a diameter between 30-40 inches (75-100 cm). In one specific embodiment, the cylinder has a diameter of 36 inches (91 cm).

As noted above, the cylinder thickness may be between 0.010 inches and 0.300 inches (0.254 mm to 7.62 mm). In more specific embodiments, the cylinder thickness is between 0.020 inches and 0.150 inches (0.50 mm to 3.8 mm). In one specific embodiment, the cylinder thickness is 0.145 inches (3.68 mm).

As noted above, the cylinder may be made of steel. Exemplary steel includes ultra high strength steel, 4340 steel, or 1080 steel. Alternatively, the cylinder may be formed of an alloy.

It has been found that a band in the form of a metal or high strength polymer cylinder yields good results. It was previously known that seamless, metal cylinders yield good results, as discussed in International Publication No. WO 2020/142665. A seamless, metal cylinder may have a consistent thickness about the entire circumference, thereby minimizing stress concentrations. By contrast, a cylinder having a seam formed by a welding process would have a different thickness at the seam, which may create stress concentrations. Despite this known problem, however, testing has shown that seamed, metal or high strength polymer cylinders may yield surprisingly good results.

Seamed, metal or high strength polymer cylinders have additional manufacturing benefits compared to seamless cylinders. It is difficult to forge a cylinder having a diameter between 20-50 inches and a thickness between 0.010 inches and 0.300 inches. Forging a cylinder with such dimensions may result in cracks, micro-cracks, or other irregularities. Therefore, in prior embodiments, a seamless cylinder with a diameter between 20-50 inches and a thickness between 0.300 inches to 1 inch was made by a rough forging process. The cylinder was then machined or lathed to a desired thickness of between 0.010 inches and 0.300 inches. The machining or lathing may be performed in multiple steps. The cylinder may also be subjected to heat treatment steps and polishing steps. Such a process may be time intensive, and may produce undesirable waste.

In another alternative prior embodiment, a seamless cylinder with a diameter between 20-50 inches and a thickness between 0.300 inches to 1 inch was made by a rough forging process. The thickness of the cylinder was then reduced by a cold forming process.

By contrast, a seamed, metal or high strength polymer cylinder may be formed from a sheet of metal or high strength polymer having a thickness between 0.010 inches and 0.300 inches. In comparison to a forged, metal cylinder, a sheet of such thickness is less likely to result in cracks, micro-cracks, or other irregularities. Thus, manufacturing a seamed, metal or high strength polymer cylinder from a thin sheet of metal or high strength polymer may be may be advantageous, because less processing is required after such a cylinder is formed, and the resulting cylinder may be comparable to, or even have fewer stress concentrations than a seamless, metal cylinder. It should be understood, however, that the sheet may have a greater thickness that is reduced during a manufacturing process. For example, the sheet may have an initial thickness between 0.300 inches to 2 inches that is reduced.

In one embodiment, a seamed, metal cylinder is formed from a flat plate stock of steel. In another embodiment, a seamed, metal cylinder is formed from a flat plate stock of other metal, such as aluminum, tin, brass, nickel, copper, titanium, or other metal or alloy, particularly a high strength alloy. In yet another embodiment, a seamed cylinder may be formed from a high strength polymer.

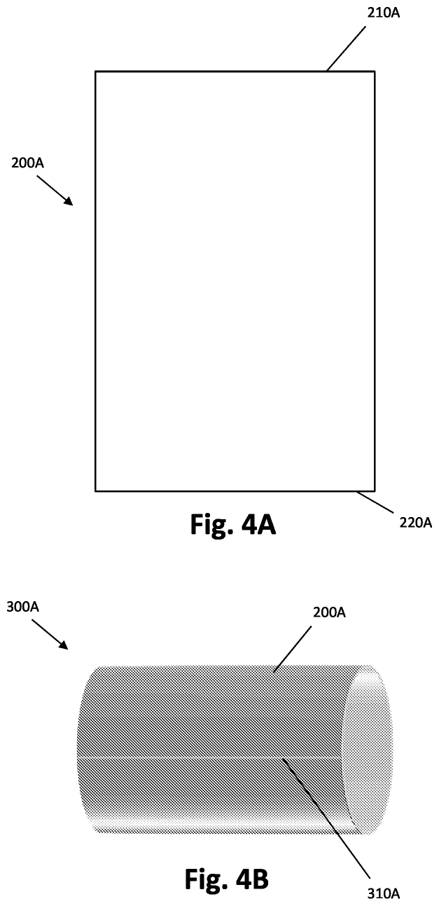

FIG. 4A is a front plan view of one embodiment of a flat plate stock or sheet 200A of metal or high strength polymer having a rectangular shape. In one embodiment, the sheet 200A is formed as a single plate to specified dimensions. In an alternative embodiment, the sheet is formed as an elongated sheet that is cut down to specified dimensions. The sheet 200A is then rolled in a longitudinal direction such that a first end or edge 210A contacts a second end or edge 220A to form a cylinder 300A.

FIG. 4B is a perspective view of the cylinder 300A. As can be seen from this view, the first end 210A and the second end 200A of the rectangular sheet 200A form a longitudinal seam 310A. The longitudinal seam 310A may then be welded. In one embodiment, the welded seam 310A is fashioned with techniques that produce a joint that is of the same composition as the matrix such as friction stir welding, laser welding, electron beam welding, or induction welding techniques. The chosen process may eliminate the need for a filler material and maintain the high strength and toughness of the material of the sheet 200A.

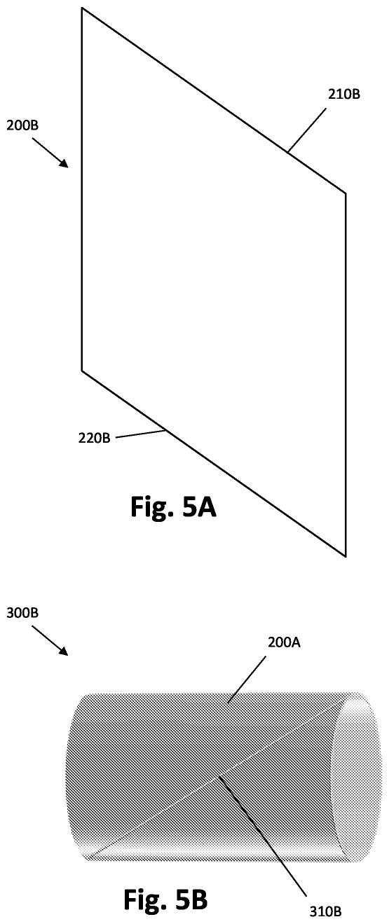

FIG. 5A is a front plan view of an alternative embodiment of a flat plate stock or sheet 200B of metal or high strength polymer having a parallelogram shape. In one embodiment, the sheet 200B is formed as a single plate to specified dimensions. In an alternative embodiment, the sheet is formed as an elongated sheet that is cut down to specified dimensions. The sheet 200B is then rolled such that a first end or edge 210B contacts a second end or edge 220B to form a cylinder 300B.

FIG. 5B is a perspective view of the cylinder 300B. As can be seen from this view, the first end 210B and the second end 200B of the parallelogram-shaped sheet 200B form a diagonal seam 310B. The diagonal seam 310B may then be welded, using one of the welding processes discussed above for a longitudinal seam.

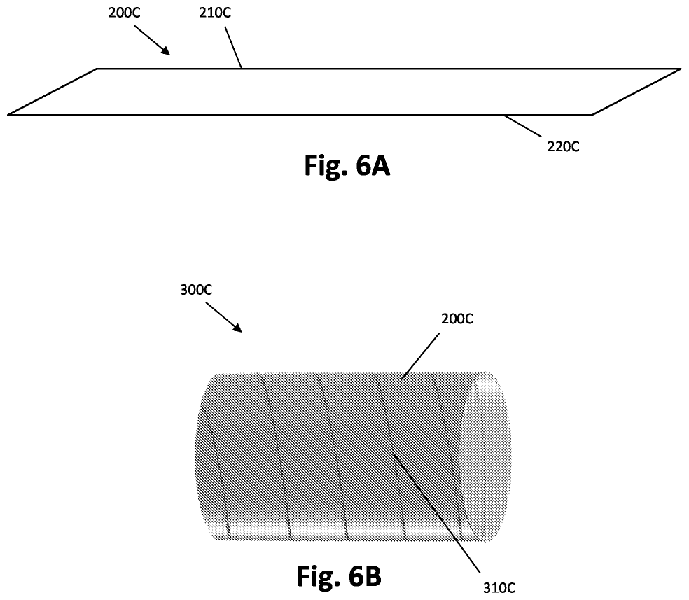

FIG. 6A is a front plan view of another alternative embodiment of a flat plate stock or sheet 200C of metal or high strength polymer having an elongated parallelogram shape. In one embodiment, the sheet 200C is formed as a single plate to specified dimensions. In an alternative embodiment, the sheet is formed as an elongated sheet that is cut down to specified dimensions. The sheet 200C is then spiraled such that a first side or edge 210C contacts a second side or edge 220C in a spiral formation along a resulting cylinder 300C.

FIG. 6B is a perspective view of the cylinder 300C. As can be seen from this view, the first side 210C and the second side 200C of the elongated parallelogram form a spiral seam 310C of the cylinder 300C. The spiral seam 310C may then be welded, using one of the welding processes discussed above for a longitudinal seam.

The examples shown in FIGS. 4-6 are not intended to be limiting. It should be understood that other seams may be employed. For example, the seams may be non-linear, such as a curve or wave-shaped seam.

In one embodiment, no post-production processing is performed after the seam is welded. In other words, no machining, resizing, or heat-treatment is performed. In an alternative embodiment, after the welding step, a stress relieving operation may be performed to alleviate any stresses after formation of the cylinder. For example, a cold forming process may be performed

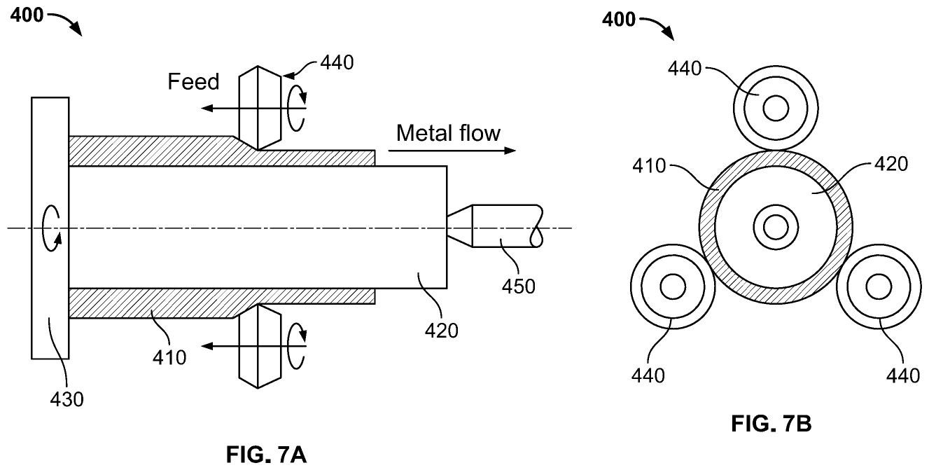

In one embodiment, the cold forming process is a reverse flow forming process, as illustrated in FIGS. 7A,B. FIG. 7A illustrates a cross-sectional view of a reverse flow forming system 400, while FIG. 7B illustrates a front view of the reverse flow forming system 400. In this system, a seamed cylinder 410 (such as any one of the cylinders 300A, 300B, 300C described above) is placed on a mandrel 420 having a spindle 430. After the cylinder 410 is placed on the mandrel 420, the spindle 430 rotates the mandrel 420 and the cylinder 410 in a first direction. A plurality of rollers 440 engage the cylinder 410 and the rollers 440 rotate in a second direction opposite the first direction. A tailstock 450 provides support for the system.

The rollers 440 then move towards the spindle. In one embodiment, the rollers 440 are spaced such that the thickness of the welded seam is reduced to the same thickness of the rest of the cylinder 410, while the wall thickness of the cylinder 410 is not otherwise changed. In another embodiment, the rollers 440 are spaced such that the movement of the spindle reduces both the thickness of the welded seam and the wall thickness of the cylinder 410. In this embodiment, the movement of the rollers 440 further causes the material of the cylinder to move in a direction opposite to the travel direction of the rollers 440.

In the illustrated embodiment, three rollers are employed. In alternative embodiments, any number of rollers may be employed.

In addition to reducing the thickness of the welded seam, the cold forming process may also improve surface finish and strengthen the material. After the cold forming process, the cylinder may also be subjected to heat treatment steps and polishing steps.

In one embodiment, the rollers 440 are spaced from the mandrel 420 by a distance equal to the desired thickness of the finished cylinder. Thus, in such an embodiment, the thickness of the cylinder 410 (including the thickness of the welded seam) is reduced to the desired thickness by a single pass of the rollers 440. In an alternative embodiment, the rollers 440 are first spaced by a distance greater than the desired thickness of the finished cylinder. In such an embodiment, after a first pass of the rollers 440, the rollers 440 are returned to an axial starting position and the distance between the rollers 440 and the mandrel 420 is reduced. A second pass of the rollers is then performed. If the thickness of the cylinder is still greater than desired, the process can be repeated for as many passes as desired. In all embodiments, the rollers 440 may be staggered both axially and radially.

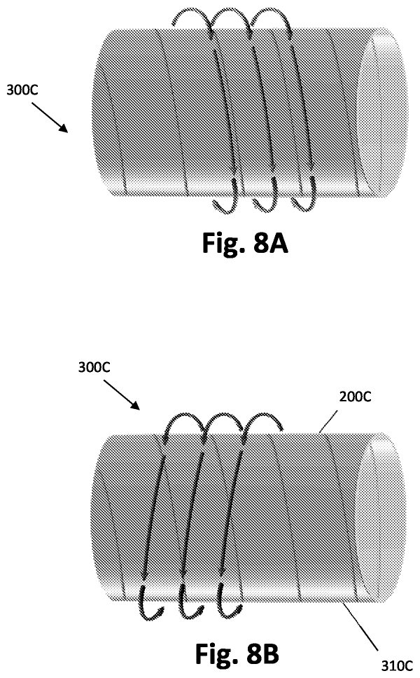

When the cylinder 410 has a diagonal weld (such as that shown in cylinder 300B) or a spiral weld (such as that shown in cylinder 300C), the rotation direction of the rollers can vary with respect to the direction of the weld. For example, FIG. 8A is a perspective view of the cylinder of FIG. 6B with arrows indicating that the rollers travel in a complimentary direction of the weld. Alternatively, FIG. 8B is a perspective view of the cylinder of FIG. 6B with arrows indicating that the rollers travel in a direction counter to the weld.

The mechanical properties and fatigue properties of the cylinder 410 may be substantially different after the flow forming process due to the resulting microstructure. It is known that microstructure within in the material is tied directly to the mechanical and fatigue properties. By plastically deforming the material through cold working during the flow forming process, the development of an improved microstructure is projected to not only alleviate stresses at the weld line but result in improvement of mechanical and fatigue properties within the final part.

While the band layer and tread rubber layer have been described with respect to non-pneumatic tires, it should be understood that they may also be employed in pneumatic tires, such as run-flat pneumatic tires.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A non-pneumatic tire comprising:
a lower ring having an axis of rotation;
an upper ring coaxial with the lower ring;
support structure extending from the lower ring to the upper ring; and
a circumferential tread extending about the upper ring, the circumferential tread including a band layer formed by a seamed cylinder constructed of a single material and a tread rubber layer directly attached to the band layer.

2. The non-pneumatic tire of claim 1, wherein the band layer is directly attached to the upper ring.

3. The non-pneumatic tire of claim 1, wherein the single material of the band layer is steel.

4. The non-pneumatic tire of claim 1, wherein the single material of the band layer is a polymeric material.

5. The non-pneumatic tire of claim 1, wherein the single material has an ultimate tensile strength of at least 410 MPa.

6. The non-pneumatic tire of claim 1, wherein the seamed cylinder has a longitudinal seam.

7. The non-pneumatic tire of claim 1, wherein the seamed cylinder has a diagonal seam.

8. The non-pneumatic tire of claim 1, wherein the seamed cylinder has a spiral seam.

9. The non-pneumatic tire of claim 1, wherein the single material has a surface with an average surface roughness of less than 25 microns.

10. A method of making a non-pneumatic tire, the method comprising:
providing an assembly with a lower ring, an upper ring coaxial with the lower ring, and support structure extending from the lower ring to the upper ring;
providing a sheet of material;
forming the sheet of material into a cylinder, such that a first edge of the sheet of material contacts a second edge of the sheet of material;
welding the first edge to the second edge to form a welded joint of a seamed cylinder;
placing the seamed cylinder about the upper ring; and
providing tread rubber about the seamed cylinder.

11. The method of claim 10, further comprising cold forming the seamed cylinder to thin a wall of the seamed cylinder.

12. The method of claim 10, further comprising cold forming the seamed cylinder to reduce a thickness of the welded joint.

13. The method of claim 12, wherein the cold forming of the seamed cylinder includes reverse flow forming the seamed cylinder.

14. The method of claim 13, wherein the reverse flow forming is performed in a direction complimentary to the welded joint.

15. The method of claim 13, wherein the reverse flow forming is performed in a direction counter to the welded joint.

16. A method of making a tire tread, the method comprising:
providing a sheet of material;
forming the sheet of material into a cylinder, such that a first edge of the sheet of material contacts a second edge of the sheet of material;
welding the first edge to the second edge to form a welded joint of a seamed cylinder; and
providing tread rubber about the seamed cylinder.

17. The method of claim 16, further comprising cold forming the seamed cylinder

18. The method of claim 16, further comprising heat treating the seamed cylinder.

19. The method of claim 16, wherein the welding of the first edge to the second edge includes at least one of friction stir welding, laser welding, electron beam welding, and induction welding.

20. The method of claim 16, further comprising cutting the sheet of material to a desired dimension before forming the sheet of material into the cylinder.
